(19) United States
(12) Patent Application Publication
(10) Pub. No.: US 2022/0210102 A1
(43) Pub. Date: Jun. 30, 2022

(54) A System and Method for Allowing Messaging Between a First Computing Device Operated by a First User and a Second Computing Device Operated by a Second User and a Structured Message Data Set for Use in that System and Method

(71) Applicant: TipeME Holdings Pty Ltd, Birkdale (AU)

(72) Inventor: Shane Isaac, Birkdale (AU)

(21) Appl. No.: 17/599,623

(22) PCT Filed: Mar. 29, 2019
(86) PCT No.: PCT/AU2019/050282

§ 371 Date: Sep. 29, 2021

(30) Foreign Application Priority Data
Mar. 29, 2018 (AU) 2018901064

(51) Int. Cl. H04L 51/046; H04L 51/10; H04L 51/18; H04L 51/234; G06F 3/0484

(52) U.S. Cl. CPC H04L 51/046; H04L 51/10; G06F 3/0484; H04L 51/34; H04L 51/18

(57) ABSTRACT

A system for allowing messaging between a first computing device operated by a first user and a second computing device operated by a second user. The system includes a first and a second messaging module, in the form of a combination of hardware and software of smartphone including one or more processors, memory, communications interfaces, and power supply. The first messaging module provides a first message field into which a user is able to enter a plurality of text elements. In response, the processor compiles timing data associated with the text elements and generates a message that is indicative of the text elements and timing data. A communications module allows communication of the message between smartphones. The second messaging module provides a second message field on interface to playback the text elements to a user in accordance with the timing data.

### FIELD OF THE INVENTION

The present invention relates to a system and method for allowing messaging between a first computing device operated by a first user and a second computing device operated by a second user and a structured message data set for use in that system and method.

The invention has been developed specifically for use with text messages sent using smartphones and other handheld computing devices and will be described hereinafter with reference to that application. However, it will be appreciated that the invention is not limited to that particular field of use and is also applicable to other computing devices and messages.

### DISCUSSION OF THE PRIOR ART

Any discussion of the prior art throughout the specification should in no way be considered as an admission that such prior art is widely known or forms part of common general knowledge in the field.

With the widespread use and popularity of text messaging, instant messaging and other similar short message services there have been considerable efforts made to enhance the functionality offered by those messaging channels. This includes attempts to provide more dynamic modes of operation to convey more information and a wider variety of information to make for a richer user experience. A well-known advance has included the introduction of emoticons and other graphical objects in messages.

While there have been some advancements made, as a whole the available messaging remains text-based and static due to the technical limitations or technical underpinnings of the available messaging channels. Some attempts at dynamic devices include dynamic emoticons in web-blogs and video files of text messaging being compiled. The former is often disrupted as the emoticons are linked to a separate or external data source for a limited time only, while the latter requires the use of large amounts of bandwidth on both the smartphone on which the message is compiled and the smartphone on which the message is received and reproduced.

Accordingly, there is a need for improved systems and methods for allowing messaging between a first computing device operated by a first user and a second computing device operated by a second user.

### SUMMARY OF THE INVENTION

It is an object of the preferred embodiments of the present invention to overcome or ameliorate at least one of the disadvantages of the prior art, or to provide a useful alternative.

According to a first aspect of the invention there is provided a system for allowing messaging between a first computing device operated by a first user and a second computing device operated by a second user, the system including:
a first messaging module on the first computing device for providing:
   a first message field into which the first user is able to enter a plurality of text elements;
   timing data associated with the text elements; and
   a message that is indicative of the text elements and the timing data;
a communications module for allowing communication of the message from the first computing device to the second computing device; and
a second messaging module on the second computing device that is responsive to the message for extracting the text elements and the timing data and for providing a second message field to playback the text elements to the second user in accordance with the timing data.

In an embodiment the text elements include one of: a single text character; and a string of text characters.

In an embodiment at least one of the text elements includes one or more control characters.

In an embodiment the first user is able to enter into the first field data elements other than text elements.

In an embodiment each of the data elements other than text elements is a media file.

In an embodiment the media file is selected from the group including: an audio file; a video file; an image file; and the like.

In an embodiment the timing data is derived from a sequencing of the entry of the text elements into the first message field.

In an embodiment the timing data is derived from a chronology of the entry of the text elements into the first message field.

In an embodiment the timing data is derived from timing input to the first computing device by the first user.

In an embodiment the timing input includes updating the timing data to change one or more of: the sequencing for one or more of the elements relative to another of the elements; and the chronology of one or more of the elements relative to another of the elements.

In an embodiment the timing data includes a playback variation field for one or more of the elements and the further input includes updating the playback variation field.

In an embodiment the second module is responsive to the playback variation field for a given element for selectively presenting that element to the second user during a given playback of the text elements.

In an embodiment the selective presentation is responsive to whether the playback has previously occurred on the second device.

In an embodiment the selective presentation is responsive to the number of times the playback has previously occurred on the second device.

According to a second aspect of the invention there is provided a system for allowing messaging between a first computing device operated by a first user and a second computing device operated by a second user, the system including:
a first messaging module on the first computing device for providing:
   a first message field into which the first user is able to enter a plurality of data elements;
   timing data associated with the data elements; and
   a message that is indicative of the data elements and the timing data;
a communications module for allowing communication of the message from the first computing device to the second computing device; and
a second messaging module on the second computing device that is responsive to the message for extracting the data elements and the timing data and for providing a second message field to playback the data elements to the second user in accordance with the timing data.

In an embodiment the data elements are selected from the group including: text characters; text strings; and media files.

In an embodiment the media file is selected from the group including: an audio file; a video file; an image file; and the like.

According to a third aspect of the invention there is provided a method for allowing messaging between a first computing device operated by a first user and a second computing device operated by a second user, the method including the steps of:
installing a first messaging module on the first computing device for providing:
   a first message field into which the first user is able to enter a plurality of text elements;
   timing data associated with the text elements; and
   a message that is indicative of the text elements and the timing data;
allowing communication of the message from the first computing device to the second computing device; and
installing a second messaging module on the second computing device that is responsive to the message for extracting the text elements and the timing data and for providing a second message field to playback the text elements to the second user in accordance with the timing data.

According to a fourth aspect of the invention there is provided a method for allowing messaging between a first computing device operated by a first user and a second computing device operated by a second user, the method including the steps of:
installing a first messaging module on the first computing device for providing:
   a first message field into which the first user is able to enter a plurality of data elements;
   timing data associated with the data elements; and
   a message that is indicative of the data elements and the timing data;
allowing communication of the message from the first computing device to the second computing device; and
installing a second messaging module on the second computing device that is responsive to the message for extracting the data elements and the timing data and for providing a second message field to playback the data elements to the second user in accordance with the timing data.

According to a fifth aspect of the invention there is provided a computing device for operating by a user, the device including:
a user interface for receiving user input from the user;
memory for storing an instance of application software;
a processor for accessing and executing the application software for providing:
   a message field with the user interface into which the user is able to enter a plurality of data elements by providing user input;
   timing data associated with the data elements; and
   a message that is indicative of the data elements and the timing data; and
a communications interface for allowing the computing device to communicate the message with at least one other computing device that is operated by another user.

In an embodiment the at least one other computing device includes a user interface for providing user output to the second user, memory for storing another instance of application software and a processor for accessing and executing the application software for: extracting the data elements and the timing data; and providing a further message field to playback the data elements to the second user in accordance with the timing data.

According to a sixth aspect of the invention there is provided a method of allowing a user to operate a computing device, the method including the steps of:
receiving user input from the user with the user interface;
storing an instance of application software in memory;
providing a processor for accessing and executing the application software for providing:
   a message field into which the user is able to enter a plurality of data elements by providing user input;
   timing data associated with the data elements; and
   a message that is indicative of the data elements and the timing data; and
allowing the computing device to communicate the message with at least one other computing device that is operated by another user.

According to a seventh aspect of the invention there is provided a computing device for operating by a user, the device including:
a user interface for providing user output to the user;
memory for storing an instance of application software;
a communications interface for allowing the computing device to receive a message from at least one other computing device; and
a processor for accessing and executing the application software for:
   being responsive to the message for extracting a plurality of data elements and timing data associated with the data elements; and
   providing with the user interface a second message field to playback the data elements to the user in accordance with the timing data.

According to an eighth aspect of the invention there is provided a method for allowing a user to operate a computing device, the method including the steps of:
providing user output to the user with a user interface;
storing in memory an instance of application software;
allowing the computing device to receive a message from at least one other computing device; and
providing a processor for accessing and executing the application software for:
   being responsive to the message for extracting a plurality of data elements and timing data associated with the data elements; and
   providing with the user interface a second message field to playback the data elements to the user in accordance with the timing data.

According to a ninth aspect of the invention there is provided a structured message data set that is compiled on a first computing device for allowing a message to be conveyed to a second computing device, the message data set including:
a message field containing a plurality of data elements; and
timing data associated with the data elements, wherein a playback of the data elements on the second device in accordance with the timing data defines the message.

In an embodiment the timing data includes one or more of: sequencing data; and chronological data.

In an embodiment at least some of the timing data relates to a subset of the data elements.

In an embodiment at least some of the timing data relates to a single data element.

In an embodiment the first computing device is operated by a first user and includes a first user interface for receiving user input from the first user, and wherein the data elements are included in the message field by the first user providing user input to the first user interface.

In an embodiment the first computing device includes a first messaging module that is responsive to either or both of the sequencing and/or the chronology of the data elements being included in the message field for deriving the timing data.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, importance, or in any other manner.

Unless the context clearly requires otherwise, in the claims below and the description herein, any one of the terms “comprising”, “comprised of” or “which comprises” is an open term that means “including at least the elements/features that follow, but not excluding others”. Thus, the term “comprising”, when used in the claims, should not be interpreted as being !imitative to the means or elements or steps listed thereafter. For example, the scope of the expression “a device comprising A and B” should not be limited to devices consisting only of elements A and B. Any one of the terms “including” or “which includes” or “that includes” as used herein is also an open term that also means “including at least the elements/features that follow the term, but not excluding others”. Thus, the term “including” is synonymous with and means “comprising”, and can be used interchangeably.

As used herein, the term “exemplary” is in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Preferred embodiments of the invention will now be described, by way of example only, with reference to the accompanying drawings in which:

FIG. 1 is a schematic representation of a system according to an embodiment of the invention; and

FIG. 2 is a flowchart illustrative of an exemplary operation of the system of FIG. 1.

### DETAILED DESCRIPTION OF THE PREFERRED EMBODIMENTS

Described herein are a system and method for allowing messaging between a first computing device operated by a first user and a second computing device operated by a second user and a structured message data set for use in that system and method.

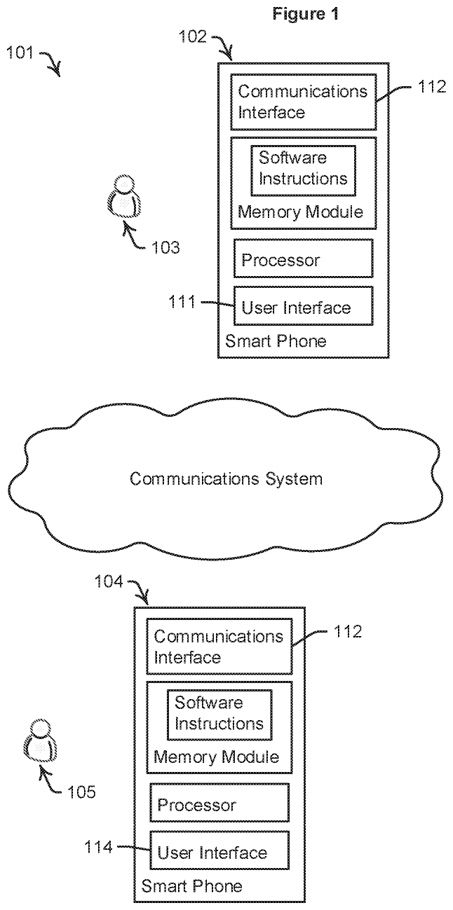

Referring to FIG. 1 there is illustrated a system 101 for allowing messaging between a first computing device, in the form of a smartphone 102, operated by a first user 103 and a second computing device, in the form of a smartphone 104, operated by a second user 105. System 101 includes a first messaging module, in the form of a combination of hardware and software of smartphone 102 including one or more processors, memory, one or more communications interfaces, a power supply, and other such components. Smartphone 102 also includes a user interface 111 for allowing user 103 to provide user input to the smartphone and to allow smartphone 102 to provide user output to user 103. The first messaging module provides a first message field, presented at user output to user 103 on the user interface, into which user 103 is able to enter a plurality of text elements. In response to the entry of the text elements, the processor compiles timing data associated with the text elements and generates a message that is indicative of the text elements and the timing data. A communications module, in the form of the one or more communications interfaces 112, allows communication of the message from smartphone 102 to smartphone 104, typically via a common communications system. A second messaging module on smartphone 104 takes the form of a combination of hardware and software of smartphone 104, including one or more processors, memory, one or more communications interfaces, a power supply, and other such components. Smartphone 104 also includes a user interface 114 for allowing user 105 to provide user input to smartphone 104 and to allow smartphone 104 to provide user output to user 105. The second messaging module is responsive to the message for extracting the text elements and the timing data and for providing a second message field on interface 114 to playback the text elements to user 105 in accordance with the timing data.

In some embodiments user 103 is able to select not to include the timing data in the message, which result in the message being sent to smartphone 4 as a conventional text message.

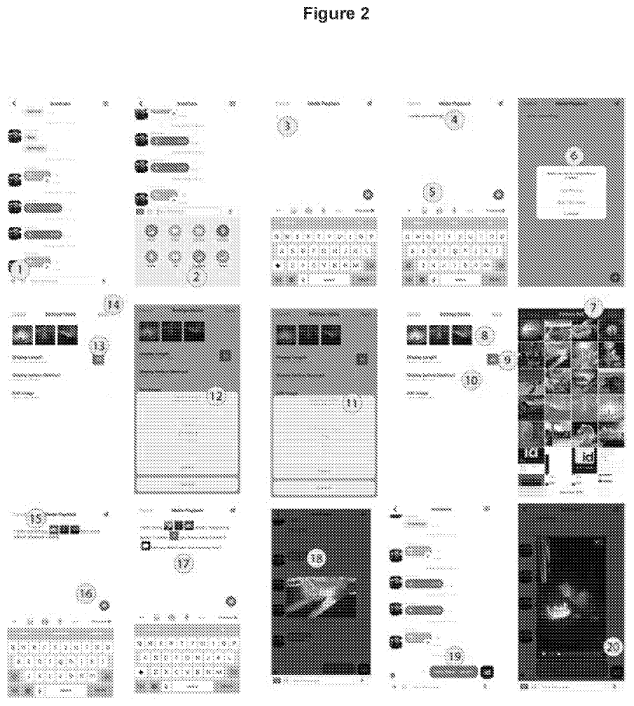

An exemplary operation of system 101 will be provided with reference to FIG. 2. In broad terms, this embodiment allows user 103 to send a message to user 105, or to broadcast the message to a plurality of such other users. Those users who are recipients of such a message are able to playback the message. The message is able to be configured such that each time the message is viewed—that is, played-back—the content relayed by the message is able to change or be altered in light of the timing information included in the message. It is possible, therefore, for user 103 to compile a message on smartphone 102 that, when broadcast, is able to be played back different on successive playbacks for a given recipient, or differently for different recipients. It is also possible for a message to be configured to never playback in the same way twice.

In the operation illustrated in FIG. 2, system 101 is implemented as a messaging system where the messages can be sent in a one-on-one chat or a group chat.

While the following description focuses on a ‘media’ playback feature involving media elements, it will be appreciated that the embodiment is also applicable to a playback using text only. The text only playback allows user 103 to type any text character, string of text characters or the like—including control characters—into the text field indicated by reference numeral 1. As user 103 types, the first message module records every movement in the message field, including the sequence and chronology and whether the change is to add a new character, delete an existing character, and the like. This allows the first message module to compile the element data and the timing data for the proposed message.

In this embodiment, user 103 does not have to send the message as one which is able to be played back. If that decision is taken, then user 103, after entering the required message in the message field, need only taps a send icon, as shown. This will result in the message being send as a standard message representative of the text contained in the message field at the time of tapping the send icon. That is, no timing data or deleted text will be sent.

To send a message containing the timing data and any deleted data elements, user 103 presses on the send icon for at least a predetermined period—in this embodiment, one second—and both the message data and the timing data will be included in the message. That is, the message will include all the desired artefacts of its compilation, which in some instances will include a full history of the creation of the message as typed (including both sequencing and chronology) and otherwise constructed by user 103 whether that involved deletion, re-writing or other such editing.

At step 1 in FIG. 2 user 103 is able to send a playback message in accordance with the invention following typing in the message field (shown as a text field) as described above. If user 103 wishes to send a media playback element then he or she taps the illustrated plus icon to access a larger menu.

At step 2, user 103 taps on the playback feature to open in interface 111 a media playback section. At step 3 the media playback section is opened and there is a large text field. This text field operates similarly to the message field explained above for text entry, where the message module records each action having occurred, the sequence in which it occurred and the chronology of and between the actions.

At step 4 user 103 begins to type a message into the text field. It should be noted in the illustrated lower left of the screen (that is, the touchscreen of smartphone 102, which is part of interface 111) there is an option offered by with two arrow icons, being a fast forward icon and a looking icon. This icon allows user 103 to control how fast the ultimately generated message is to be played back to the recipient. This control is also offered for messages including only text.

At step 5, when viewed from left to right, there are options offered to user 103, being:
playback speed (as mentioned above).
tap to add media files to the playback flow in at step 4.
tap to add a live photo/media file to step 4.
tap to add an audio file to step 4.
access an invisible data area to pull media or data from there into step 4.
preview the draft message as now complied.

In other embodiments different options are offered to user 103 instead of or in addition to the above options to allow other playback effects.

At step 6 user 103 opts to tap on the second option in the preceding list of options above to add a media file to the message being compiled. In this instance, user 103 then selects a photo—that is, an image file—to include within the message.

At step 7 user 103 selects three photos, which are comprised of three separate image files. It should be noted that photos or any other media do not need to be selected together. It is possible to select a subset of the desired photos at this step and then to add more text once the interface returns to step 4. This allows user 103 to then repeat steps 6 and 7 to add other media, photos etc. that are separated in the overall sequence of data elements by the intermediate text.

At step 8 the three photos selected at step 7 are added and for convenience the settings screen for the media content of the playback is opened. User 103 is then able to tap on any media item in this area to focus on it and then interact with further options, the major ones of which are set out below.

At step 9 user 103 taps this option if there is a desire to select how long a given photo is to display on the recipient's screen during playback before it moves on to displaying the next data element in the message. That next item data element could be text, audio, video another photo, or the like.

A step 10 user 103 is able to tap this option to select how many times the associated media file to be viewed during successive playbacks by the recipient before it is no longer presented within a subsequent playback.

As step 11 there are displayed options in this embodiment for step 9. In particular, user 103 is able to select the length of time the photo will be displayed to the recipient before the playback proceeds to the next item. Note that it is possible to opt for no time limit and, if this is selected, the recipient needs to manually tap the image during playback for the next data element in the message to be displayed.

At step 12 there are displayed are the options in this embodiment for step 10. It is open to user 103 to select how many times a specific data element—that is, a text character, text string, a piece of media, etc.—is displayed before it is no longer shown in a successive playback by user 105. It will be appreciated that although the logic and options are illustrated with specific reference to a photo, they are equally applicable to text, video and other data elements.

In this embodiment the timing data is compiled to be specific for each recipient. Take the illustrative example of a video that is compiled by user 103 to play twice times before it no longer will be played-back and the message is broadcast to user 105 and a further user (not shown). If user 105 initiates a single playback of the message, and then initiates the playback again, during both playbacks user 105 will be presented with the video. The third time user 105 initiates the playback, he or she will not be presented with the video. If the further user then initiates a playback with that user's computing device, the further user is presented with the video, and similarly should the further user initiate the next playback of the message. However, on the third initiation of the playback, the further user will not be presented with the video.

In other embodiments broadcast messages are responsive to all playback initiations by all recipients in deriving a count of playbacks.

At step 13, any time set in step 11 is displayed on the main settings screen for convenience.

At step 14 user 103 is able to confirm approval of the message as now compiled by tapping the Apply button, which returns the module to step 4.

At step 15 the three images have been added to the sequence of data elements at step 4 and user 103 has then entered more text characters into the message field. If user 103 wishes to edit the media files or any part of the entered text, he or she simply need tap and hold on the item to be edited and an option will appear to access the settings screen at step 8.

At step 16 user 103 is able to save any partially or fully compiled message via a save option.

At step 17 there is illustrated another example of a message created using system 1 for playback on smartphone 104 and including a media file. It will be noted that the message for playback contains text, images, audio and a video. It is possible to construct and create such message randomly or otherwise in the sequence of data elements.

At step 18 user 103 sends the created message to smartphone 104 and user 105 initiates playback of the message. The message is played-back as it was created and based on numerous items of logic to detect the timing, frequency and positioning of the data elements in the played-back message. As specifically illustrated in FIG. 2, an image is displayed with one second remaining before it is no longer displayed.

At step 19 the text elements of the message continue to play within the message field illustrated by interface 114 of smartphone 104. It should be noted that when compiling the message user 103 has the ability to speed up or slow down the typing speed.

At step 20 the message is being shown as being allowed to continue to play until it arrived at the video item set in step 17. After the video ends, the next data element in the message will be presented, which includes the text string “bet you didn't see that coming hey?.”

In this embodiment user 105 is unable to skip ahead or back during the playback of the message. In some embodiments, user 105 is able to skip ahead or back and/or also provided with the ability to change the playback speed as it relates to text elements or other data elements.

An example of the data structure used for a message of the preferred embodiments is provided below:

```
{
  “speed” : 2,
  “text” : “Hello ♦♦, this is a test that includes all media types ♦, the
purpose of this text to if to write a document about it ♦”,
  “attachments” : {
    “{49, 1}” : {
      “timpeLapse” : 0,
      “display” : 4,
      “id” : “26B161F2-0B49-41B0-B861-560D3CBAD348”,
      “type” : 1,
      “url” :
      “https://.../26B161F2-0B49-41B0-B861-560D3CBAD348.mov”
    },
    “{82, 1}” : {
      “timpeLapse” : 0,
      “display” : 4,
      “id” : “4D6866EE-3714-4D40-A234-B991DF4FDE97”,
      “type” : 2,
      “url” :
      “https://.../4D6866EE-3714-4D40-A234-B991DF4FDE97.aac”
    },
    “{6, 1}” : {
      “timpeLapse” : 5,
      “display” : 5,
      “id” : “7AFFF059-D0B6-45C2-93DD-00DF4DE16C76”,
      “type” : 0,
      “url” :
      “https://.../7AFFF059-D0B6-45C2-93DD-00DF4DE16C76.jpg”
    },
    “{7, 1}” : {
      “timpeLapse” : 0,
      “display” : 0,
      “id” : “A3530430-7D21-4FC7-B1E0-BB765A17D07E”,
      “type” : 0,
      “url” :
      “https://.../A3530430-7D21-4FC7-B1E0-BB765A17D07E.jpg”
    }
  }
}
```

The message is indicative of the data elements that are available to be displayed and timing data for allowing the sequencing and chronology of that display to be directed by user 103. In the above structure use is made of the following main fields:
speed—this field is able to have a value of 1, 2 or 3
text—this field contains the raw text included in the message that will be displayed within the user interface 114 (although excluding the “♦” characters which are not text items). Each ♦ (non text item) references a media item and is not presented as such by interface 114 to user 105. Even if the text is all presented, the use of the special character allow a sense of mystery to remain. During playback of a message the non-text item ♦ transforms to a large format to display the linked media or other element, before returning to its original state at the end of the playback of that media element.
attachments—this field is a dictionary that contains the media element's instance. For example, if position {6, 1} contains a media item, this means the string at index 6 and length of it is 1 (length of the media item is always 1, but in other embodiments, the length can be greater than 1)

The data structure used in the present embodiment for media elements is as follows:

```
{
  “timpeLapse” : 0,
  “display” : 0,
  “id” : “A3530430-7D21-4FC7-B1E0-BB765A17D07E”,
  “type” : 0,
  “url” : “https://.../A3530430-7D21-4FC7-B1E0-BB765A17D07E.jpg”
}
```

The fields in this structure include:
timpeLapse—this field displays time (in seconds) of each media item, although only for images as video and other media typically have predetermined times. If the field value is 0 the image will not automatically close until user 105 taps it. For video and audio elements the value in this filed is always set at 0.
display—this field is the number of times that a user is able to view each relevant media element. If the user reaches total quota, the next playback of the message will ignore the media element and progress to the next data element in the sequence defined by the message. If the value in this field is 0, the media element is able to be viewed an unlimited number of times.
id—this field is the media element's unique identifier, created by the app either locally on smartphone 103 and/or 105, or centrally on a system server (not shown) to which both the smartphones communicate. This is used to name the media element and manage the number of times it is able to be presented to user 105.
type—this field specifies the type of media for the media element. In this embodiment a value of 0 is for IMAGE, 1 is for VIDEO, and 2 is for AUDIO.
url—this field contains a link to the media element on the system server.

The second messaging module, either alone or in combination with the system server, executes software to provide a dictionary to manage the remaining number of times to call back the media elements and display them. This activity is used to populate a data field remainingTimesOfCalledPlayback. If a data element has unlimited views (that is, the display field is set 0) then it will be disregarded by this check.

When, during the playback of a message, the second message modules arrives at a media element, it checks the dictionary using the media element's unique id. After each view of valid media element with a setting over 0 the value will be reduced by 1. Once this value is depleted the media element will not be presented during the next playback of the message. For example, if a media element has a display value of 0 it is disregarded and logic is not applied to it as far as display is concerned. However, if a media element has a value of over 1, then the that value is stored to remainingTimesOfCalledPlayback at which time that value once depleting to one will cause the media to be completely ignored.

It will be appreciated that the disclosure above provides various significant systems and methods for allowing messaging between a first computing device operated by a first user and a second computing device operated by a second user, as well as a significant structured message data set for use in such systems and methods.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Reference is made in this specification to “data elements”. This term is used to describe a single data element such as a text character or file, or strings of text characters, including special characters, and combinations or groupings of files. A plurality of these elements, and combinations of different types of elements, are able to be included in a single message. However, that is not to imply that all the data elements contained within a given message need be all stored together or transmitted together, simply that the message, however stored or transmitted, provides a functional whole when assembled or accessed.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, a touch screen, one or more manually depressible buttons, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, a smart phone, a switch or bridge, or any machine capable of executing a set of instructions (sequential or otherwise) that specify actions to be taken by that machine.

One embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term “coupled” or “connected”, when used in the claims, should not be interpreted as being limited to direct connections only. The terms “coupled” and “connected,” along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” or “connected” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A system for allowing messaging between a first computing device operated by a first user and a second computing device operated by a second user, the system including:
a first messaging module on the first computing device for providing:
a first message field into which the first user is able to enter a plurality of text elements;
timing data associated with the text elements; and
a message that is indicative of the text elements and the timing data;
a communications module for allowing communication of the message from the first computing device to the second computing device; and
a second messaging module on the second computing device that is responsive to the message for extracting the text elements and the timing data and for providing a second message field to playback the text elements to the second user in accordance with the timing data.

2. A system according to claim 1 wherein the text elements include one of: a single text character; and a string of text characters.

3. A system according to claim 1 wherein at least one of the text elements includes one or more control characters.

4. A system according to claim 1 wherein the first user is able to enter into the first field data elements other than text elements.

5. A system according to claim 4 wherein each of the data elements other than text elements is a media file.

6. A system according to claim 5 wherein the media file is selected from the group including: an audio file; a video file; an image file; and the like.

7. A system according to claim 1 wherein the timing data is derived from a sequencing of the entry of the text elements into the first message field.

8. A system according to claim 1 wherein the timing data is derived from a chronology of the entry of the text elements into the first message field.

9. A system according to claim 1 wherein the timing data is derived from timing input to the first computing device by the first user.

10. A system according to claim 9 wherein the timing input includes updating the timing data to change one or more of: the sequencing for one or more of the elements relative to another of the elements; and the chronology of one or more of the elements relative to another of the elements.

11. A system according to claim 9 wherein the timing data includes a playback variation field for one or more of the elements and the further input includes updating the playback variation field.

12. A system according to claim 11 wherein the second module is responsive to the playback variation field for a given element for selectively presenting that element to the second user during a given playback of the text elements.

13. A system according to claim 12 wherein the selective presentation is responsive to whether the playback has previously occurred on the second device.

14. A system according to claim 12 wherein the selective presentation is responsive to the number of times the playback has previously occurred on the second device.

15. A system for allowing messaging between a first computing device operated by a first user and a second computing device operated by a second user, the system including:
a first messaging module on the first computing device for providing:
a first message field into which the first user is able to enter a plurality of data elements;
timing data associated with the data elements; and
a message that is indicative of the data elements and the timing data;
a communications module for allowing communication of the message from the first computing device to the second computing device; and
a second messaging module on the second computing device that is responsive to the message for extracting the data elements and the timing data and for providing a second message field to playback the data elements to the second user in accordance with the timing data.

16. A system according to claim 15 wherein the data elements are selected from the group including: text characters; text strings; and media files.

17. A system according to claim 15 wherein the media files is selected from the group including: an audio file; a video file; an image file; and the like.

18. A method for allowing messaging between a first computing device operated by a first user and a second computing device operated by a second user, the method including the steps of:
installing a first messaging module on the first computing device for providing:
a first message field into which the first user is able to enter a plurality of text elements;
timing data associated with the text elements; and
a message that is indicative of the text elements and the timing data;
allowing communication of the message from the first computing device to the second computing device; and
installing a second messaging module on the second computing device that is responsive to the message for extracting the text elements and the timing data and for providing a second message field to playback the text elements to the second user in accordance with the timing data.

19. A method for allowing messaging between a first computing device operated by a first user and a second computing device operated by a second user, the method including the steps of:
installing a first messaging module on the first computing device for providing:
a first message field into which the first user is able to enter a plurality of data elements;
timing data associated with the data elements; and
a message that is indicative of the data elements and the timing data;
allowing communication of the message from the first computing device to the second computing device; and
installing a second messaging module on the second computing device that is responsive to the message for extracting the data elements and the timing data and for providing a second message field to playback the data elements to the second user in accordance with the timing data.

20. A computing device for operating by a user, the device including:
a user interface for receiving user input from the user;
memory for storing an instance of application software;
a processor for accessing and executing the application software for providing:
a message field with the user interface into which the user is able to enter a plurality of data elements by providing user input;
timing data associated with the data elements; and
a message that is indicative of the data elements and the timing data; and
a communications interface for allowing the computing device to communicate the message with at least one other computing device that is operated by another user.

21. A device according to claim 20 wherein the at least one other computing device includes a user interface for providing user output to the second user, memory for storing another instance of application software and a processor for accessing and executing the application software for: extracting the data elements and the timing data; and providing a further message field to playback the data elements to the second user in accordance with the timing data.

22. A method of allowing a user to operate a computing device, the method including the steps of:
receiving user input from the user with the user interface;
storing an instance of application software in memory;
providing a processor for accessing and executing the application software for providing:
a message field into which the user is able to enter a plurality of data elements by providing user input;
timing data associated with the data elements; and
a message that is indicative of the data elements and the timing data; and
allowing the computing device to communicate the message with at least one other computing device that is operated by another user.

23. A computing device for operating by a user, the device including:
a user interface for providing user output to the user;
memory for storing an instance of application software;
a communications interface for allowing the computing device to receive a message from at least one other computing device; and
a processor for accessing and executing the application software for:
being responsive to the message for extracting a plurality of data elements and timing data associated with the data elements; and
providing with the user interface a second message field to playback the data elements to the user in accordance with the timing data.

24. A method for allowing a user to operate a computing device, the method including the steps of:
providing user output to the user with a user interface;
storing in memory an instance of application software;
allowing the computing device to receive a message from at least one other computing device; and
providing a processor for accessing and executing the application software for:
being responsive to the message for extracting a plurality of data elements and timing data associated with the data elements; and
providing with the user interface a second message field to playback the data elements to the user in accordance with the timing data.

25. A structured message data set that is compiled on a first computing device for allowing a message to be conveyed to a second computing device, the message data set including:
a message field containing a plurality of data elements; and
timing data associated with the data elements, wherein a playback of the data elements on the second device in accordance with the timing data defines the message.

26. A message data set according to claim 25 wherein the timing data includes one or more of: sequencing data; and chronological data.

27. A message data set according to claim 25 or 26 wherein at least some of the timing data relates to a subset of the data elements.

28. A message data set according to claim 27 wherein at least some of the timing data relates to a single data element.

29. A message data set according to any one of claim 25 wherein the first computing device is operated by a first user and includes a first user interface for receiving user input from the first user, and wherein the data elements are included in the message field by the first user providing user input to the first user interface.

30. A message data set according to claim 29 wherein the first computing device includes a first messaging module that is responsive to either or both of the sequencing and/or the chronology of the data elements being included in the message field for deriving the timing data.
